(19) United States
(12) Patent Application Publication
(10) Pub. No.: US 2012/0163210 A1
(43) Pub. Date: Jun. 28, 2012

(54) THROUGHPUT DERIVATION METHOD FOR INTERFERENCE ANALYSIS IN WIRELESS COMMUNICATION SYSTEMS WITH INTERFERENCE AVOIDANCE FUNCTION

(75) Inventor: Seonhui YUN, Daejeon (KR)

(73) Assignee: ELECTRONICS AND TELECOMMUNICATIONS RESEARCH INSTITUTE, Daejeon (KR)

(21) Appl. No.: 13/332,403

(22) Filed: Dec. 21, 2011

(30) Foreign Application Priority Data
Dec. 23, 2010 (KR) 10-2010-0133964

(51) Int. Cl. H04W 72/08; H04W 24/02

(52) U.S. Cl. 370/252

(57) ABSTRACT

A throughput derivation method in a wireless communication system includes generating a victim link and an interference link by setting an input parameter, calculating a desired Received Signal Strength (dRSS) for a specific channel and an interfering Received Signal Strength (iRSS) for the specific channel, allocating a channel for interference avoidance by comparing the calculated iRSS with a threshold that is a signal transmission/reception permission level, calculating a Signal to Interference-plus-Noise Ratio (SINR) using dRSS and iRSS for the allocated channel, and calculating a packet error rate using the calculated SINR and computing a throughput using the calculated packet error rate.

### CROSS-REFERENCE TO RELATED APPLICATIONS

The present application claims priority of Korean Patent Application No. 10-2010-0133964, filed on Dec. 23, 2010, which is incorporated herein by reference in its entirety.

### BACKGROUND OF THE INVENTION

1. Field of the Invention

Exemplary embodiments of the present invention relate to a throughput derivation method for interference analysis in wireless communication systems with an interference avoidance function; and, more particularly, to a throughput derivation method for deriving a change in throughput using an interference avoidance mechanism according to an interfering receiving signal strength received from an interfering transmitter to a victim receiver in a wireless communication system.

2. Description of Related Art

Monte-Carlo method is a method of specifying several parameter values related to an interference environment and statistically calculating a probability of interference. The Monte-Carlo method has a slightly high complexity and shows a difference in probability of interference depending on an input parameter. However, the Monte-Carlo method can simulate all interference environments.

Through interference analysis using the Monte-Carlo method, it is possible to determine a sharing possibility of a frequency and provide a technical parameter such as a transmission mask for frequency sharing. Because of these features, a probability of interference is derived using the Monte-Carlo method in the existing interference analysis between wireless communication systems.

FIG. 1 illustrates an example in which interference occurs between antenna systems according to a related art.

Referring to FIG. 1, it is assumed that an antenna system subjected to interference analysis is referred to as a ‘victim antenna system’ and an antenna system causing interference to the victim antenna system is referred to as an ‘interfering antenna system.’ Here, the victim antenna system includes a wanted transmitter 10 and a victim receiver 20, and the interfering antenna system includes an interfering transmitter 30 and a wanted receiver 40.

The strength of a signal received from the wanted transmitter 10 to the victim receiver 20 is defined as a desired Received Signal Strength (dRSS), and the strength of a signal received from the interfering transmitter 30 to the victim receiver 20 is defined as an interfering Receiving Signal Strength (iRSS). In this case, the signal received from the interfering transmitter 30 to the victim receiver 20 acts as a factor that causes interference to the victim receiver 20.

In addition, a link made between the wanted transmitter 10 and the victim receiver 20 is defined as a ‘victim link,’ and a link made between the victim receiver 20 and the interfering transmitter 30 is defined as an ‘interfering link.’

A process of calculating a probability of interference between antenna systems using the Monte-Carlo method will be described as follows.

First, parameters respectively corresponding to the wanted transmitter 10, the victim receiver 20, the interfering transmitter 30 and the wanted receiver 40 are set. In addition, a link parameter between the wanted transmitter 10 and the victim receiver 20 is set. Subsequently, the dRSS received from the wanted transmitter 10 to the victim receiver 20 and the iRSS received from the interfering transmitter 30 to the victim receiver 20 are calculated.

Thus, the probability P of interference is calculated to be equal to or less than a threshold (C/I: Carrier-to-Interference ratio) required by the dRSS/iRSS in the system, when the dRSS is received at a value equal to or greater than a receive sensitivity level.

That is, when a specific parameter among the input parameters does not have a fixed value but is inputted to have a value in a range having a specific distribution pattern, the dRSS and the iRSS are calculated by respectively applying values in corresponding ranges, and a number of times when the ‘dRSS/iRSS’ does not exceed the threshold (C/I) may be divided into a total number of times, thereby calculating the probability of interference.

However, as wireless communication markets are changed with data communications as a centerpiece, there has been a limitation in analyzing a change in amount of data transmission, caused by interference using a probabilistic interference analysis method used in the Monte-Carlo method. To this end, there has been proposed a new method for analyzing a throughput on behalf of the probability of interference.

In the newly proposed method, the probability of interference is not calculated, but a dRSS and an iRSS are calculated so as to compute a throughput. Then, a Signal to Interference-plus-Noise Ratio (SINR) is obtained using the calculated dRSS and iRSS. Subsequently, a packet error rate is calculated, and the throughput is then obtained using the calculated packet error rate.

The method for computing the throughput is usefully applied to general data transmission system, but a unique interference avoidance algorithm existing in some communication systems. Therefore, it is required to develop a throughput computation method for a change in data according to the interference avoidance algorithm.

### SUMMARY OF THE INVENTION

An embodiment of the present invention is directed to a throughput derivation method for interference analysis in a wireless communication system with an interference avoidance function, in which a transmission channel of a victim system is determined by comparing a total iRSS received from an interfering transmitter with an arbitrary threshold, and a throughput is computed according to the determined transmission channel.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a throughput derivation method in a wireless communication system includes generating a victim link and an interference link by setting an input parameter, calculating a desired Received Signal Strength (dRSS) for a specific channel and an interfering Receiving Signal Strength (iRSS) for the specific channel, allocating a channel for interference avoidance by comparing the calculated iRSS with a threshold that is a signal transmission/reception permission level, calculating a Signal to Interference-plus-Noise Ratio (SINR) using dRSS and iRSS for the allocated channel, and calculating a packet error rate using the calculated SINR and computing a throughput using the calculated packet error rate.

The allocating the channel for interference avoidance may allocate an arbitrary channel among available channels in the channel set by the input parameter when an iRSS for a currently allocated channel exceeds the threshold.

The allocating the channel for interference avoidance may further include calculating an SINR using dRSS and iRSS for a currently allocated channel when the iRSS for the currently allocated channel is smaller than the threshold or when no available channel exists in the channel set by the input parameter.

### BRIEF DESCRIPTION OF THE DRAWINGS

FIG. 1 illustrates an example in which interference occurs between antenna systems according to a related art.

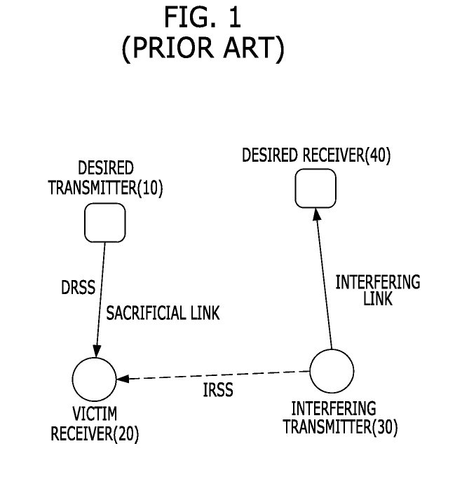

FIG. 2 is flowchart illustrating a throughput derivation method to which an interference avoidance function in accordance with an embodiment of the present invention.

FIG. 3 is a graph illustrating a correlation between packet error rate and SINR.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

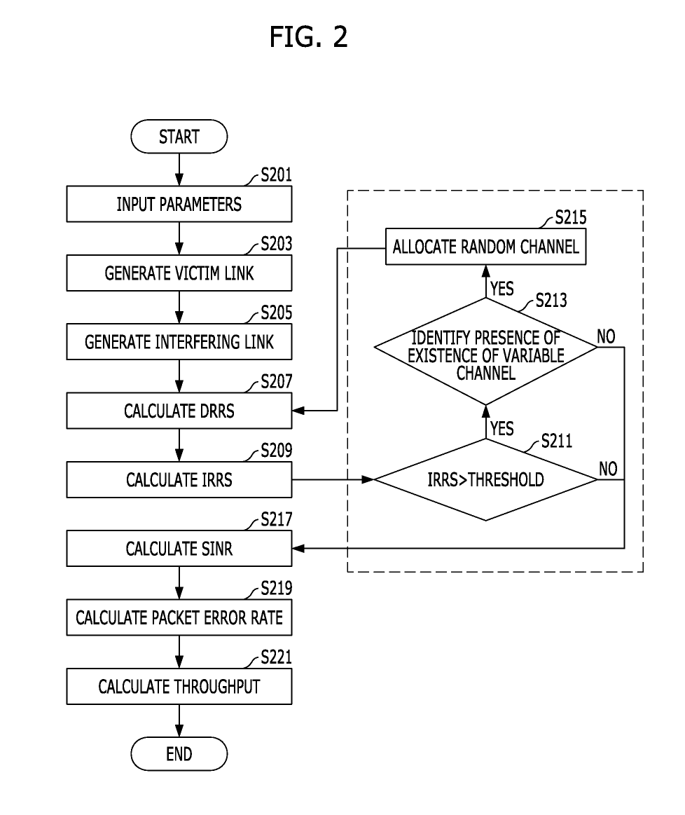

FIG. 2 is flowchart illustrating a throughput derivation method to which an interference avoidance function in accordance with an embodiment of the present invention.

Referring to FIG. 2, in the throughput derivation method in accordance with the embodiment of the present invention, input parameters are individually set with respect to a wanted transmitter, a victim receiver, an interfering transmitter and a wanted receiver (S201). In the present invention, the input parameters set in a selected range of probability may be applied to the wanted transmitter, the victim receiver, the interfering transmitter and the wanted receiver, respectively.

In order to derive a throughput, a ‘victim link’ is generated using the input parameters of the wanted transmitter and the victim receiver (S203), and an ‘interference link’ is generated using the input parameters of the interfering transmitter and the wanted receiver (S205).

A dRSS received from the wanted transmitter to the victim receiver is calculated using the generated victim link and interference link (S207).

As an embodiment, the dRSS received from the wanted transmitter to the victim receiver may be calculated by the following Expression 1.

dRSS=p_{wt}^{Supplied}+g_{wt→vr}(fᵥᵣ)−pl_{wt} [symbol] ᵥᵣ(fᵥᵣ)+g_{vr→wt}(fᵥᵣ) Expression 1

In Expression 1, p_{wt}^{Supplied} denotes a power supplied to the wanted transmitter, and g_{wt→vr}(fᵥᵣ) denotes an antenna gain from the wanted transmitter to the victim receiver. Also, pl_{wt} [symbol] ᵥᵣ(fᵥᵣ) denotes a path loss between the wanted transmitter and the victim receiver, and g_{vr→wt}(fᵥᵣ) denotes an antenna gain from the victim receiver to the wanted transmitter.

Next, an iRSS received from the interfering transmitter to the victim receiver is calculated based on the set input parameters (S209).

Generally, interference mechanisms may be divided into a blocking interference mechanism, an unwanted emission interference mechanism and an intermodulation interference mechanism. Each of the interference mechanisms can finally derive the iRSS through the following Expressions 2 to 4.

As an embodiment for calculating the iRSS, the iRSS may be calculated using the following Expression 2 based on the blocking interference mechanism.

iRSS_{blocking}=pᵢₜ^{Supplied}+gᵢₜ^{PC}+g_{it→vr}(Fᵢₜ)−pl_{it⇄vr}(fᵥᵣ)−aᵥᵣ+g_{vr→it}(fᵥᵣ) Expression 2

In Expression 2, iRSS_{blocking} denotes a blocking iRSS received from the interference transmitter. Also, pᵢₜ^{Supplied} denotes a power supplied to the interference transmitter, and gᵢₜ^{PC} denotes a power control gain of the interference transmitter. Also, g_{it→vr}(fᵥᵣ) denotes an antenna gain from the interfering transmitter to the victim receiver, and plᵢₜ [symbol] ᵥᵣ(fᵥᵣ) denotes a path loss between the interfering transmitter and the victim receiver. Also, aᵥᵣ denotes a blocking attenuation of the victim receiver, and g_{vr→it}(fᵥᵣ) denotes an antenna gain from the victim receiver to the interference transmitter.

As another embodiment for calculating the iRSS, the iRSS may be calculated using the following Expression 3 based on the unwanted emission interference mechanism.

iRSS_{unwanted}=emission_{IT}(fᵢₜ−fᵥᵣ)+gᵢₜ^{PC}+g_{it→vr}(fᵢₜ)−plᵢₜ [symbol] ᵥᵣ(fᵥᵣ)+g_{vr→it}(fᵥᵣ) Expression 3

In Expression 3, iRSS_{wanted} denotes an iRSS received from an unwanted emission of the interfering transmitter to the victim receiver, and emission_{IT}(fᵢₜ−fᵥᵣ) denotes an iRSS received to a reception bandwidth of the victim receiver.

As another embodiment for calculating the iRSS, the iRSS may be calculated using the following Expression 4 based on the intermodulation interference mechanism.

iRSS_{intermod i,j}=2iRSS_{int i}+iRSS_{int j}−3_{intermod}(f₀−fᵥᵣ)−3sensᵥᵣ−9 dB Expression 4

In expression 4, iRSS_{intermod i,j} denotes an intermodulation iRSS received from an i-th interfering transmitter and a j-th interference transmitter, and intermod(f₀−fᵥᵣ) denotes a third intermodulation attenuation. Also, 3sensᵥᵣ denotes a sensitivity of the victim receiver.

In specific wireless communication systems, a unique interference avoidance function exits in each of the systems, and the interference avoidance function is not considered in the conventional throughput analysis method. Thus, a throughput can be more substantially obtained by adding the interference avoidance function to the throughput analysis method. This will be described as an embodiment of the present invention.

Referring to FIG. 2, channels in a corresponding frequency band are set suitable for probabilistic conditions set in the input parameters when the victim link and the interference link are generated. The iRSS calculated using the generated victim link and interference link is compared with a threshold set for a victim system (S211).

In a case where the iRSS is smaller than the threshold as the compared result (S211), it is assumed that the victim system determines that an interference signal in a corresponding channel exists in a signal transmission/reception permission level and performs transmission of the interference signal. Then, an SINR is calculated without a separate change in channel (S217).

In a case where the iRSS is greater than the threshold as the compared result (S211), the victim system determines that the interference signal in the corresponding channel exceeds the signal transmission/reception permission level, and scans other channels. To this end, the victim system identifies whether or not other available channels except the current channel in the channels set by the parameters exist (S213).

In a case where available channels exist as the identified result (S213), the channels are randomly allocated within a variable channel range (S215), subsequent steps from the step (S207) of calculating the dRSS are repeatedly performed. Accordingly, a channel in which the interference signal exists in the signal transmission/reception permission level of the victim system is searched.

However, in a case where available channels do not exist the identified result (S213), the channel allocation is stopped, and an SINR is calculated (S217).

After the dRSS and iRSS for the channel set through the interference avoidance operation are calculated, the SINR of the dRSS and the iRSS is calculated (S217).

The SINR may be computed by dividing the dRSS into the sum of the iRSS and a noise level (NoiseLevel).

$$SINR = \frac{dRSS}{iRSS + NoiseLevel} \qquad Expression 5$$

After the SINR of the dRSS and the iRSS is calculated, a packet error rate may be calculated using the computed SINR (S219).

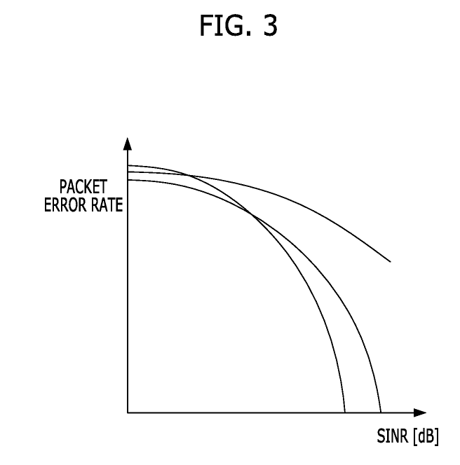

FIG. 3 is a graph illustrating a correlation between packet error rate and SINR.

Referring to FIG. 3, when the SINR is a specific SINR, the packet error rate may be calculated depending on a corresponding system and a data type. Generally, the packet error rate for SINR may be changed depending on a system, an environment and a length of data.

Then, a throughput is computed based on the calculated packet error rate (S221). In accordance with the present invention, the throughput may be computed using the feature that the packet error rate is changed depending on the SINR.

As an embodiment of deriving the throughput using the packet error rate, the throughput may be calculated by the following Expression 6.

The throughput has a close relation with the packet error rate, and a packet error may occur in a process of transmitting an acknowledge (Ack) packet in response to a process of transmitting a data packet. Since the packet error may occur when transmission times of the victim system and the interference system collide with each other, a total error rate may be calculated in consideration of the collision of the transmission times. The throughput is determined by the total data transmission quantity and the packet error rate. Thus, the throughput may be calculated by the following Expression 6.

Throughput=R·[1−P_{timecol}{(1−PER_{DATA})(1−PER_{ACK})}] Expression 6

In Expression 6, R denotes a maximum data rate of the victim system, and P_{timecol} denotes a temporal collision probability between the victim system and the interference system. Also, PER_{DATA} denotes a packet error rate of the data packet, and PER_{ACK} denotes a packet error rate of the Ack packet.

As another embodiment of deriving the throughput using the packet error rate, when the packet error rate of the Ack packet is not separately calculated, the throughput may be simply computed by the following Expression 7.

Throughput=R·[1−P_{timecol}(1−PER_{DATA})²] Expression 7

In Expression 7, R denotes a maximum data rate of the victim system, and P_{timecol} denotes a temporal collision probability between the victim system and the interference system. Also, PER_{DATA} denotes a packet error rate of the data packet.

In accordance with the exemplary embodiments of the present invention, a victim system using an interference avoidance function can derive a throughput changed by an interference system near the victim system.

The above-described methods can also be embodied as computer programs. Codes and code segments constituting the programs may be easily construed by computer programmers skilled in the art to which the invention pertains. Furthermore, the created programs may be stored in computer-readable recording media or data storage media and may be read out and executed by the computers. Examples of the computer-readable recording media include any computer-readable recoding media, e.g., intangible media such as carrier waves, as well as tangible media such as CD or DVD.

While the present invention has been described with respect to the specific embodiments, it will be apparent to those skilled in the art that various changes and modifications may be made without departing from the spirit and scope of the invention as defined in the following claims.

What is claimed is:

1. A throughput derivation method in a wireless communication system, the method comprising:
generating a victim link and an interference link by setting an input parameter;
calculating a desired Received Signal Strength (dRSS) for a specific channel and an interfering Received Signal Strength (iRSS) for the specific channel;
allocating a channel for interference avoidance by comparing the calculated iRSS with a threshold that is a signal transmission/reception permission level;
calculating a Signal to Interference-plus-Noise Ratio (SINR) using dRSS and iRSS for the allocated channel; and
calculating a packet error rate using the calculated SINR, and computing a throughput using the calculated packet error rate.

2. The method of claim 1, wherein said allocating of the channel for interference avoidance allocates an arbitrary channel among available channels in the channel set by the input parameter when an iRSS for a currently allocated channel exceeds the threshold.

3. The method of claim 2, wherein said allocating of the channel for interference avoidance further comprising calculating an SINR using dRSS and iRSS for a currently allocated channel when the iRSS for the currently allocated channel is smaller than the threshold or when no available channel exists in the channel set by the input parameter.

4. The method of claim 2, wherein the throughput is computed as follows:
Throughput=R·[1−P_{timecol}{(1−PER_{DATA})(1−PER_{ACK})}]
wherein R denotes a maximum data rate of the victim system, P_{timecol} denotes a temporal collision probability between the victim system and an interference system, PER_{DATA} denotes a packet error rate of the data packet, and PER_{ACK} denotes a packet error rate of an acknowledge (Ack) packet.

5. The method of claim 2, wherein the throughput is computed as follows:
Throughput=R·[1−P_{timecol}(1−PER_{DATA})²]
wherein R denotes a maximum data rate of the victim system, P_{timecol} denotes a temporal collision probability between the victim system and the interference system, and PER_{DATA} denotes a packet error rate of the data packet.
